(19) United States
(12) Patent Application Publication
(10) Pub. No.: US 2022/0134396 A1
(43) Pub. Date: May 5, 2022

(54) Food Product Mat Assembly

(71) Applicants: John Stallings, Rancho Dominguez, CA (US); Terri Stallings, Rancho Dominguez, CA (US)

(72) Inventors: John Stallings, Rancho Dominguez, CA (US); Terri Stallings, Rancho Dominguez, CA (US)

(21) Appl. No.: 17/087,777

(22) Filed: Nov. 3, 2020

(51) Int. Cl. B08B 17/06; A23L 3/00

(52) U.S. Cl. CPC B08B 17/06; A23V 2002/00; A23L 3/001

(57) ABSTRACT

A food product mat assembly for supporting a delivered food product above a support surface includes a mat that is positionable on a support surface in front of an entry of a building to have a delivered food product positioned thereon. The mat is foraminous to facilitate water to drain therethrough thereby inhibiting the delivered food product from being exposed to the water. A plurality of ridges each extends upwardly from the mat to support the delivered food item above the mat.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to food mat devices and more particularly pertains to a new food mat device for supporting a delivered food product above a support surface.

### (2) Description of Related Art Including Information Disclosed Under 37 CFR 1.97 and 1.98

The prior art relates to food mat devices including a floor mat for vehicles that includes a grate and a tray. The prior art discloses a food mat that includes a plurality of prominences and a sloped surface to facilitate drainage from the food mat. The prior art also discloses a modular food mat that includes a cleanable portion and a fluid absorbent portion for inhibiting a delivered food product from getting wet.

### BRIEF SUMMARY OF THE INVENTION

An embodiment of the disclosure meets the needs presented above by generally comprising a mat that is positionable on a support surface in front of an entry of a building to have a delivered food product positioned thereon. The mat is foraminous to facilitate water to drain therethrough thereby inhibiting the delivered food product from being exposed to the water. A plurality of ridges each extends upwardly from the mat to support the delivered food item above the mat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a food product mat assembly according to an embodiment of the disclosure.

FIG. 2 is a bottom view of an embodiment of the disclosure.

FIG. 3 is a top view of an embodiment of the disclosure.

FIG. 4 is a perspective in-use view of an embodiment of the disclosure.

FIG. 5 is a right side view of an embodiment of the disclosure.

FIG. 6 is a cross sectional view taken along line 6-6 of FIG. 5 of an embodiment of the disclosure.

### DETAILED DESCRIPTION OF THE INVENTION

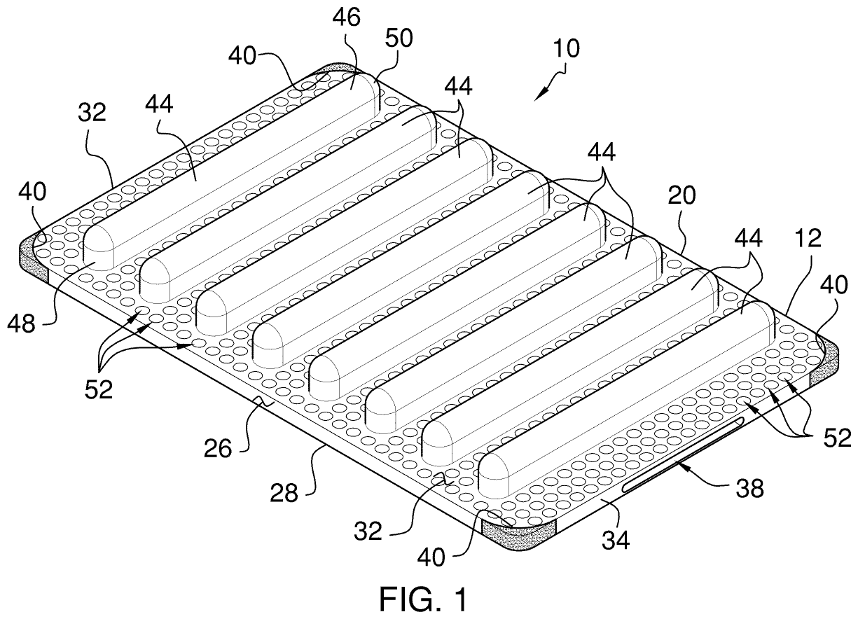

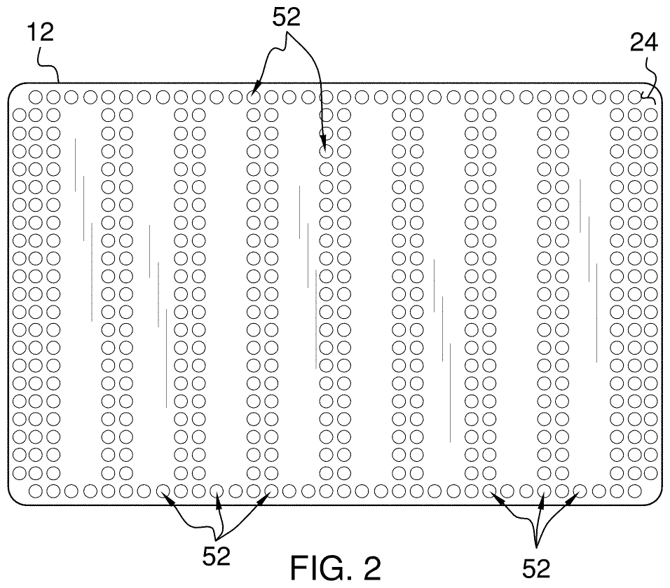

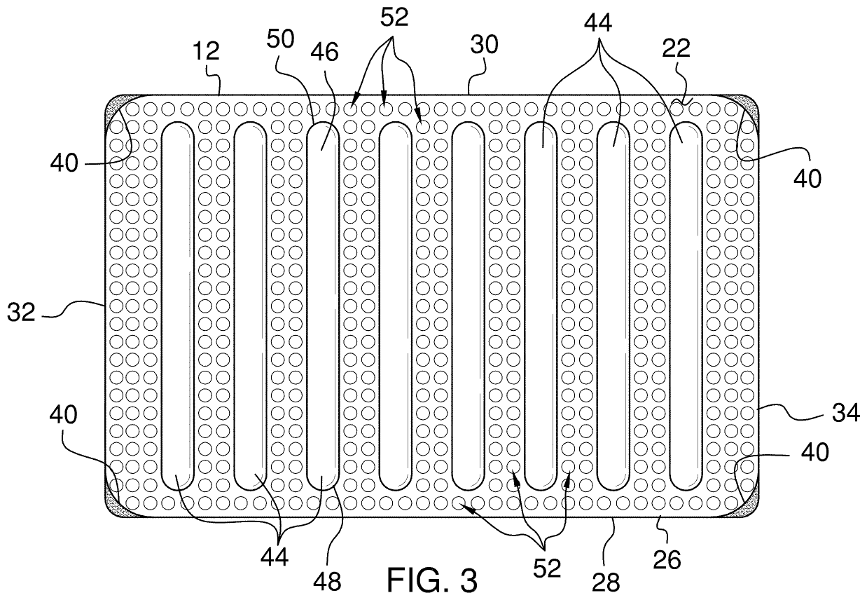

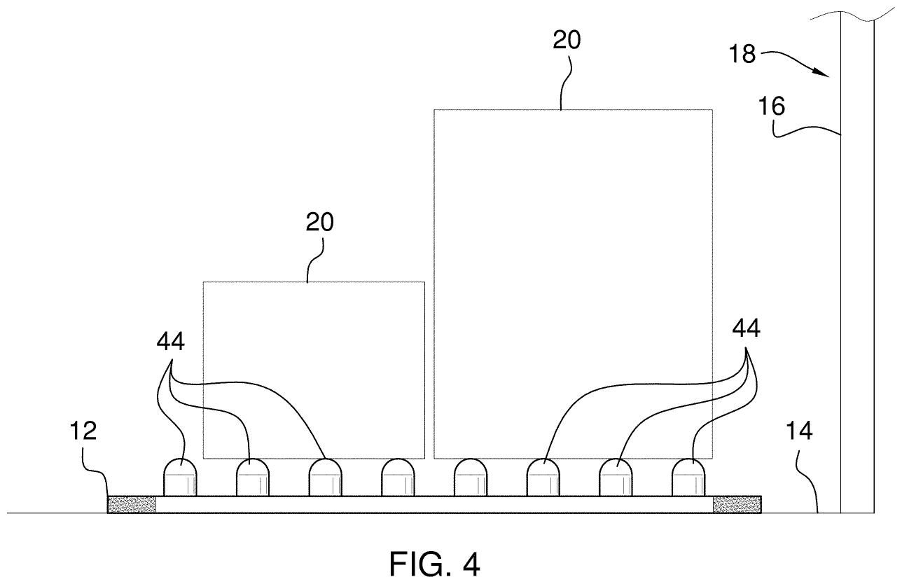

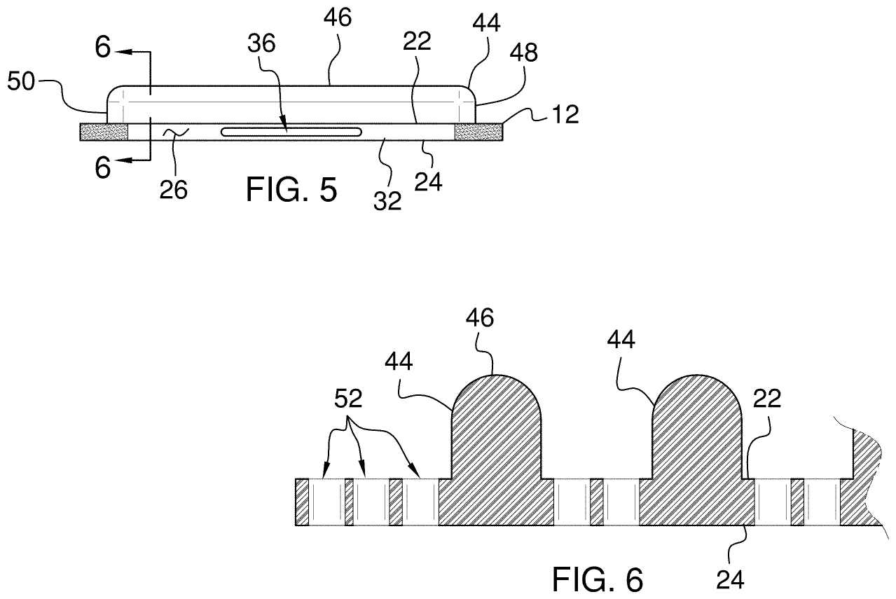

With reference now to the drawings, and in particular to FIGS. 1 through 6 thereof, a new food mat device embodying the principles and concepts of an embodiment of the disclosure and generally designated by the reference numeral 10 will be described.

As best illustrated in FIGS. 1 through 6, the food product mat assembly 10 generally comprises a mat 12 that is positionable on a support surface 14 in front of an entry 16 of a building 18. In this way a delivered food product 20 can be positioned thereon. The building 18 may be a house, an apartment building, an office building or any other occupancy where a food delivery might be delivered. The mat 12 is foraminous to facilitate water to drain therethrough thereby inhibiting the delivered food product 20 from being exposed to the water.

The mat 12 has a top surface 22, a bottom surface 24 and a perimeter surface 26 extending therebetween, and the perimeter surface 26 has a front side 28, a back side 30, a first lateral side 32 and a second lateral side 34. The first lateral side 32 has a first well 36 extending toward the second lateral side 34 to accommodate fingers of a user for gripping the mat 12. Additionally, the first well 36 is elongated to extend substantially between the front side 28 and the back side 30. The second lateral side 34 has a second well 38 extending toward the first lateral side 32 to accommodate fingers of a user for gripping the mat 12. Additionally, the second well 38 is elongated to extend substantially between the front side 28 and the back side 30.

A plurality of grips 40 is provided and each of the grips 40 is integrated into the mat 12. Each of the grips 40 is aligned with and extends around a respective one of four corners 42 of the mat 12. Moreover, each of the grips 40 is comprised of a textured material to enhance gripping the mat 12. A plurality of ridges 44 each extends upwardly from the mat 12 to support the delivered food product 20 above the mat 12. Each of the ridges 44 is positioned on the top surface 22 of the mat 12 and each of the ridges 44 extends substantially between the front side 28 and the back side 30 of the perimeter surface 26 of the mat 12. The plurality of ridges 44 is spaced apart from each other and is distributed between the first lateral side 32 and the second lateral side 34 of the perimeter surface 26 of the mat 12. Each of the ridges 44 has a rounded top side 46 and each of the ridges 44 has a rounded first end 48 and a rounded second end 50.

The mat 12 has a plurality of openings 52 each extending through the top surface 22 and the bottom surface 24 to pass water therethrough. The openings 52 are spaced apart from each other and are distributed over a substantial length and width of the mat 12 with the exception of where each of the ridges 44 is located thereby facilitating the mat 12 to be foraminous. The mat 12 is comprised of a fluid impermeable material, including but not being limited to, rubber, polyvinylchloride, silicone or other similar type of material. Additionally, each of the ridges 44 is comprised of a fluid impermeable material, including but not being limited to, rubber, polyvinylchloride, silicone or other similar type of material.

In use, the mat 12 is placed outdoors in front of the entry 16 of the building 18. In this way the delivered food product 20 can be placed on the mat 12 when the delivered food product 20 is delivered to the building 18. In this way the delivered food product 20 is supported above the ground or other support surface 14 upon which the mat 12 is resting. Additionally, the openings 52 in the mat 12 facilitate rain or other moisture that may collect on the mat 12 to pass therethrough. In this way the delivered food product 20 is inhibited from becoming wet prior to being received by the intended recipient.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food product mat assembly for supporting a delivered food product thereby inhibiting the food product from being exposed to water on the ground, said assembly comprising:
a mat being positionable on a support surface in front of an entry of a building wherein said mat is configured to have a delivered food product positioned thereon, said mat being foraminous wherein said mat is configured to facilitate water to drain therethrough thereby inhibiting the delivered food product from being exposed to the water; and
a plurality of ridges, each of said ridges extending upwardly from said mat wherein said plurality of ridges is configured to support the delivered food item above said mat.

2. The assembly according to claim 1, wherein:
said mat has a top surface, a bottom surface and a perimeter surface extending therebetween, said perimeter surface having a front side, a back side, a first lateral side and a second lateral side;
said first lateral side has a first well extending toward said second lateral side wherein said first well is configured to accommodate fingers of a user for gripping said mat, said first well being elongated to extend substantially between said front side and said back side; and
said second lateral side has a second well extending toward said first lateral side wherein said second well is configured to accommodate fingers of a user for gripping said mat, said second well being elongated to extend substantially between said front side and said back side.

3. The assembly according to claim 1, wherein:
said mat has a top surface, a bottom surface and a perimeter surface extending therebetween, said perimeter surface having a front side, a back side, a first lateral side and a second lateral side; and
each of said ridges is positioned on said top surface of said mat, each of said ridges extending substantially between said front side and said back side of said perimeter surface of said mat, said plurality of ridges being spaced apart from each other and being distributed between said first lateral side and said second lateral side of said perimeter surface of said mat.

4. The assembly according to claim 3, wherein each of said ridges has a rounded top side, each of said ridges having a rounded first end and a rounded second end.

5. The assembly according to claim 3, wherein said mat has a plurality of openings each extending through said top surface and said bottom surface wherein each of openings is configured to pass water therethrough, said openings being spaced apart from each other and being distributed over a substantial length and width of said mat with the exception of where each of said ridges is located thereby facilitating said mat to be foraminous.

6. The assembly according to claim 1, further comprising a plurality of grips, each of said grips being integrated into said mat, each of said grips being aligned with and extending around a respective one of four corners of said mat, each of said grips being comprised of a textured material wherein each of said grips is configured to enhance gripping said mat.

7. A food product mat assembly for supporting a delivered food product thereby inhibiting the food product from being exposed to water on the ground, said assembly comprising:
a mat being positionable on a support surface in front of an entry of a building wherein said mat is configured to have a delivered food product positioned thereon, said mat being foraminous wherein said mat is configured to facilitate water to drain therethrough thereby inhibiting the delivered food product from being exposed to the water, said mat having a top surface, a bottom surface and a perimeter surface extending therebetween, said perimeter surface having a front side, a back side, a first lateral side and a second lateral side, said first lateral side having a first well extending toward said second lateral side wherein said first well is configured to accommodate fingers of a user for gripping said mat, said first well being elongated to extend substantially between said front side and said back side, said second lateral side having a second well extending toward said first lateral side wherein said second well is configured to accommodate fingers of a user for gripping said mat, said second well being elongated to extend substantially between said front side and said back side;
a plurality of grips, each of said grips being integrated into said mat, each of said grips being aligned with and extending around a respective one of four corners of said mat, each of said grips being comprised of a textured material wherein each of said grips is configured to enhance gripping said mat;
a plurality of ridges, each of said ridges extending upwardly from said mat wherein said plurality of ridges is configured to support the delivered food item above said mat, each of said ridges being positioned on said top surface of said mat, each of said ridges extending substantially between said front side and said back side of said perimeter surface of said mat, said plurality of ridges being spaced apart from each other and being distributed between said first lateral side and said second lateral side of said perimeter surface of said mat, each of said ridges having a rounded top side, each of said ridges having a rounded first end and a rounded second end; and
wherein said mat has a plurality of openings each extending through said top surface and said bottom surface wherein each of openings is configured to pass water therethrough, said openings being spaced apart from each other and being distributed over a substantial length and width of said mat with the exception of where each of said ridges is located thereby facilitating said mat to be foraminous.
